(19) United States
(12) Patent Application Publication
(10) Pub. No.: US 2019/0250399 A1
(43) Pub. Date: Aug. 15, 2019

(54) METHOD OF DESIGNING FREEFORM SURFACE OPTICAL SYSTEMS WITH DISPERSION ELEMENTS

(71) Applicants: Tsinghua University, Beijing (CN); HON HAI PRECISION INDUSTRY CO., LTD., New Taipei (TW)

(72) Inventors: Ben-qi Zhang, Beijing (CN); JUN ZHU, Beijing (CN); GUO-FAN JIN, Beijing (CN); SHOU-SHAN FAN, Beijing (CN)

(21) Appl. No.: 16/246,739

(22) Filed: Jan. 14, 2019

(30) Foreign Application Priority Data
Feb. 9, 2018 (CN) 201810139879.6

(51) Int. Cl. G02B 27/00; G02B 5/18; G06F 17/50

(52) U.S. Cl. CPC G02B 27/0012; G06F 17/50; G02B 5/1847

(57) ABSTRACT

A method of designing a freeform surface optical system with dispersion elements is provided. A nondispersive spherical optical system comprising a nondispersive sphere is constructed. A dispersion element is placed on the nondispersive sphere to construct a dispersive spherical optical system comprising a dispersive sphere. The dispersive spherical optical system is constructed into a dispersive freeform surface optical system comprising a freeform surface. The coordinates of the feature data points on the freeform surface are kept unchanged, and the normal vectors are recalculated. The coordinates and new normal vectors are fitted to obtain a new freeform surface. An iterative algorithm is performed until all freeform surfaces are recalculated to new freeform surfaces.

### CROSS-REFERENCE TO RELATED APPLICATIONS

This application claims all benefits accruing under 35 U.S.C. § 119 from China Patent Application No. 201810139879.6, field on Feb. 9, 2018 in the China National Intellectual Property Administration, disclosure of which is incorporated herein by reference. The application is also related to copending applications entitled, “FREEFORM SURFACE IMAGING SPECTROMETER SYSTEM”, filed ** (Atty. Docket No. US73257).

### FIELD

The subject matter herein generally relates to a method of designing freeform surface optical systems with dispersion elements.

### BACKGROUND

Imaging spectrometers with dispersion elements are applied in a wide variety of fields, including biomedical measurements, earth remote sensing and space exploration. An optical system with dispersion elements is a key instrument of the imaging spectrometers with dispersion elements. The optical system with dispersion elements has wider fields of view, higher spectral bandwidths and higher spatial/spectral resolutions than the optical system without dispersion elements. Advancing developments in the optical system with dispersion elements has long been pursued by optical designers.

A freeform surface is a surface that cannot be represented by a spherical or a sphere. The freeform surface is a complex surface without symmetry. Freeform surface optics is regarded as a revolution in optical design. Freeform surface optics involves optical system designs that contain at least one freeform surface with no translational or rotational symmetry. With a high number of degrees of freedom surfaces, novel and high-performance optical systems can be obtained.

Conventional methods of designing freeform surface optical systems with dispersion elements are often performed through calculating an initial solution of the system according to an aberration theory, or multi-parameter optimizing an existing system. However, the freeform surface has multi variables and high degrees, there are insufficient existing initial systems, and different wavelengths of light need to be considered during designing the freeform surface optical systems with dispersion elements. Therefore, conventional methods of designing freeform surface optical systems with dispersion elements are difficult to implement.

### BRIEF DESCRIPTION OF THE DRAWINGS

Implementations of the present technology will now be described, by way of Embodiments, with reference to the attached figures, wherein:

FIG. 1 is a flow diagram of an embodiment of a method of designing a freeform surface optical system with dispersion elements.

FIG. 2 is a flow diagram of an embodiment of a method of designing a freeform surface optical system with dispersion elements.

FIG. 3 is a flow diagram of an embodiment of a method of constructing a nondispersive spherical optical system.

FIG. 4 is a process diagram of a method of constructing the nondispersive spherical optical system in FIG. 3.

FIG. 5 is a schematic view of an embodiment of a grating placing on a secondary mirror of a dispersive spherical optical system.

FIG. 6 is a schematic view of an embodiment of a method of solving a normal vector of a feature data point on a freeform surface.

### DETAILED DESCRIPTION

The disclosure is illustrated by way of embodiment and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “contact” is defined as a direct and physical contact. The term “substantially” is defined to be that while essentially conforming to the particular dimension, shape, or other feature that is described, the component is not or need not be exactly conforming to the description. The term “comprising,” when utilized, means “including, but not necessarily limited to”; it specifically indicates open-ended inclusion or membership in the so-described combination, group, series, and the like.

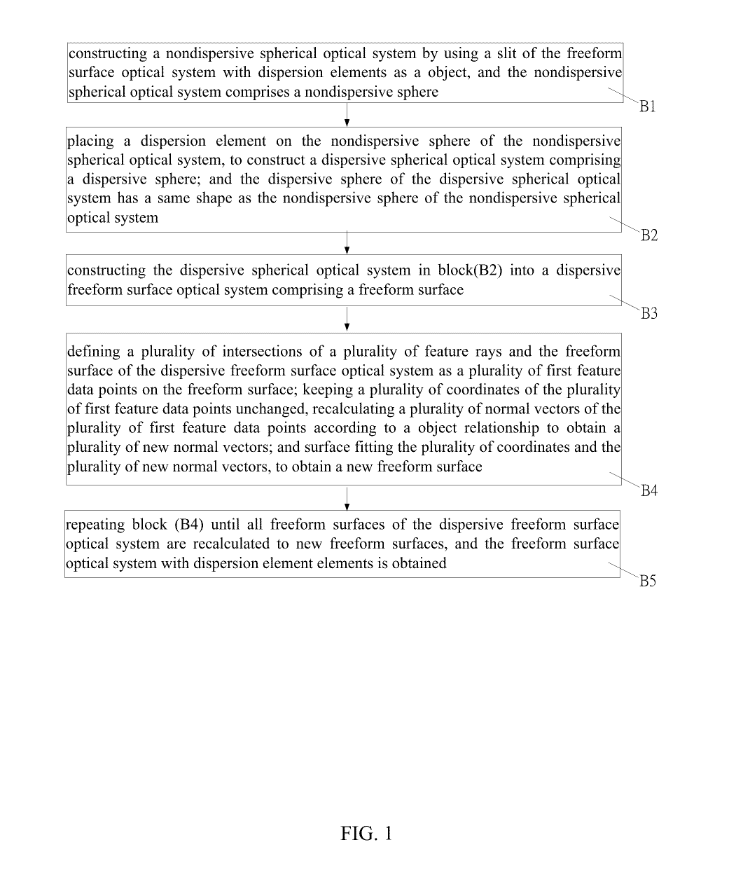

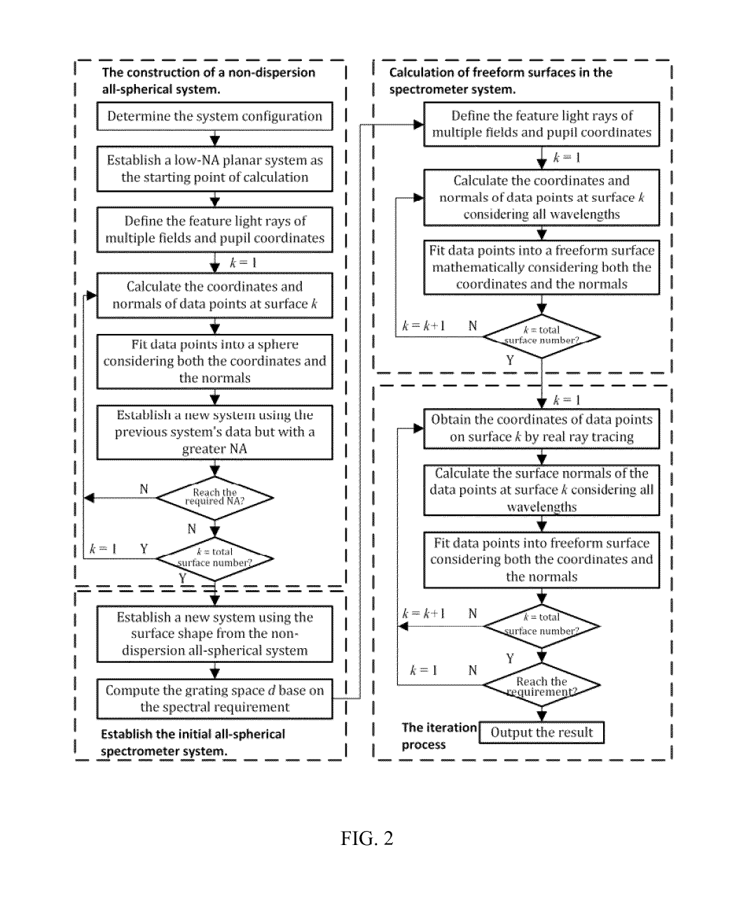

FIG. 1 and FIG. 2 show one embodiment in relation to a method of designing a freeform surface optical system with dispersion elements. The method comprises the following blocks:

block (B1), constructing a nondispersive spherical optical system by using a slit of the freeform surface optical system with dispersion elements as an object, and the nondispersive spherical optical system comprises a nondispersive sphere;

block (B2), placing a dispersion element on the nondispersive sphere of the nondispersive spherical optical system, to construct a dispersive spherical optical system comprising a dispersive sphere; and the dispersive sphere of the dispersive spherical optical system has a same shape as the nondispersive sphere of the nondispersive spherical optical system;

block (B3), constructing the dispersive spherical optical system in block (B2) into a dispersive freeform surface optical system comprising a freeform surface;

block (B4), defining a plurality of intersections of a plurality of feature rays and the freeform surface of the dispersive freeform surface optical system as a plurality of first feature data points on the freeform surface; keeping a plurality of coordinates of the plurality of first feature data points unchanged, recalculating a plurality of normal vectors of the plurality of first feature data points according to a object relationship to obtain a plurality of new normal vectors; and surface fitting the plurality of coordinates and the plurality of new normal vectors, to obtain a new freeform surface; and block (B5), repeating block (B4) until all freeform surfaces of the dispersive freeform surface optical system are recalculated to new freeform surfaces, and the freeform surface optical system with dispersion element elements is obtained.

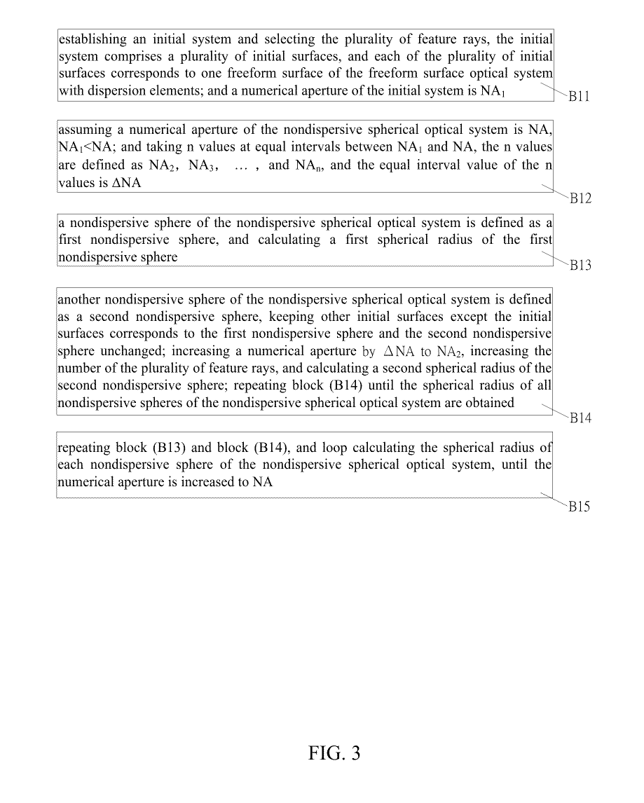

Referring to FIG. 3, in block (B1), a method of constructing the nondispersive spherical optical system comprises:

block (B11), establishing an initial system and selecting the plurality of feature rays, the initial system comprises a plurality of initial surfaces, and each of the plurality of initial surfaces corresponds to one freeform surface of the freeform surface optical system with dispersion elements; and a numerical aperture of the initial system is NA₁;

block (B12), assuming a numerical aperture of the nondispersive spherical optical system is NA, NA₁<NA; and taking n values at equal intervals between NA₁ and NA, the n values are defined as NA₂, NA₃, . . . , and NAₙ, and the equal interval value of the n values is ΔNA;

block (B13), a nondispersive sphere of the nondispersive spherical optical system is defined as a first nondispersive sphere, and calculating a first spherical radius of the first nondispersive sphere;

block (B14), another nondispersive sphere of the nondispersive spherical optical system is defined as a second nondispersive sphere, keeping other initial surfaces except the initial surfaces corresponds to the first nondispersive sphere and the second nondispersive sphere unchanged; increasing a numerical aperture by ANA to NA₂, increasing the number of the plurality of feature rays, and calculating a second spherical radius of the second nondispersive sphere; repeating block (B14) until the spherical radius of all nondispersive spheres of the nondispersive spherical optical system are obtained; and

block (B15), repeating block (B13) and block (B14), and loop calculating the spherical radius of each nondispersive sphere of the nondispersive spherical optical system, until the numerical aperture is increased to NA.

In block (B11), the initial surface can be a planar surface or a sphere. The locations and quantity of the plurality of initial surfaces can be selected according to actual needs of the freeform surface optical system with dispersion element elements. In one embodiment, the initial system is an initial planar three-mirror system; and the initial planar three-mirror system comprises three planar surfaces.

In block (B12), in one embodiment, NA₁<0.01 multiply by NA. A value of n is larger than the number of nondispersive spheres of the nondispersive spherical optical system.

In block (B13), a method for selecting the plurality of feature rays comprises steps of: M fields are selected according to the optical systems actual needs; an aperture of each of the M fields is divided into N equal parts; and, P feature rays at different aperture positions in each of the N equal parts are selected. As such, K=M×N×P different feature rays correspond to different aperture positions and different fields are fixed. The aperture can be circle, rectangle, square, oval or other shapes. In one embodiment, the aperture of each of the M fields is a circle, and a circular aperture of each of the M fields is divided into N angles with equal interval φ, as such, N=2π/φ; then, P different aperture positions are fixed along a radial direction of each of the N angles. Therefore, K=M×N×P different feature rays correspond to different aperture positions and different fields are fixed.

The plurality of intersections of the plurality of feature rays and the nondispersive sphere are defined as a plurality of second feature data points on the nondispersive sphere. Each of the plurality of second feature data points comprises coordinate information and normal information. When the nondispersive spherical optical system is ideally imaged, the plurality of feature rays finally intersects an image plane at the ideal image points after passing through the nondispersive spherical optical system. The coordinates of the ideal image points are determined by an object image relationship of the nondispersive spherical optical system, the object image relationship can be focal length or magnification.

A method of calculating a first spherical radius of the first nondispersive sphere comprises: calculating a plurality of intersections of the plurality of feature rays with the first nondispersive sphere based on a given object-image relationship and Snell's law, the plurality of intersections are the plurality of second feature data points on the first nondispersive sphere; and surface fitting the plurality of second feature data points to obtain an equation of the first nondispersive sphere and the first spherical radius of the first nondispersive sphere.

A surface located adjacent to and before the first nondispersive sphere is defined as a surface ω′, a surface located adjacent to and behind the first nondispersive sphere is defined as ω″. The plurality of second feature data points can be obtained by the intersection points of the plurality of feature rays with the surface ω′ and the surface ω″. The plurality of feature rays are intersected with the surface ω′ at a plurality of start points, and intersected with the surface ω″ at a plurality of end points. When the first nondispersive sphere and the plurality of feature rays are determined, the plurality of start points of the feature rays can also be determined. The plurality of end points can be obtained based on the object-image relationship. Under ideal conditions, the feature rays emitted from the plurality of start points on the surface ω′; pass through the second feature data points on the first nondispersive sphere; intersect with the surface ω″ at the plurality of end points; and finally intersect with the image plane at the plurality of ideal image points.

The plurality of second feature data points on the first nondispersive sphere is defined as Pᵢ(i=1, 2 . . . K), K refers the number of the feature rays. A method of calculating the plurality of second feature data points on the first nondispersive sphere comprises:

block (a): defining a first intersection point of a first feature ray R₁ and the initial surface corresponding to the first nondispersive sphere as the second feature data point P₁;

block (b): when a j^{th} (1≤j≤K−1) second feature data point Pⱼ (1≤j≤K−1) has been obtained, a unit normal vectors \vec{N}ⱼ at the j^{th} (1≤j≤K−1) second feature data point Pⱼ (1≤j≤K−1) can be calculated based on the vector form of Snell's law;

block (c): making a first tangent plane through the j^{th} (1≤j≤K−1) second feature data point Pⱼ (1≤j≤K−1), and (K−j) second intersections can be obtained by the first tangent plane intersecting with remaining (K-j) feature rays; a second intersection Qⱼ₊₁, which is nearest to the j^{th} (1≤j≤K−1) second feature data point Pⱼ (1≤j≤K−1), is fixed; and a feature ray corresponding to the second intersection Qⱼ₊₁ is defined as Rⱼ₊₁, a shortest distance between the second intersection Qⱼ₊ᵢ and the j^{th} second feature data point Pⱼ (1≤j≤K−1) is defined as dⱼ;

block (d): making a second tangent plane at (j−1) second feature data points that are obtained before the j^{th} second feature data point Pⱼ (1≤j≤K−1) respectively; thus, (j−1) second tangent planes can be obtained, and (j−1) third intersections can be obtained by the (j−1) second tangent planes intersecting with a feature ray Rⱼ₊₁; in each of the (j−1) second tangent planes, each of the third intersections and its corresponding second feature data point form an intersection pair; the intersection pair, which has the shortest distance between a third intersection and its corresponding second feature data point, is fixed; and the third intersection and the shortest distance is defined as Q′ⱼ₊₁ and d′ⱼ respectively;

block (e): comparing dⱼ and d′ⱼ, if dⱼ≤d′ⱼ, Qⱼ₊₁ is taken as the next second feature data point Pⱼ₊₁ (1≤j≤K−1); otherwise, Q′ⱼ₊₁ is taken as the next second feature data point Pⱼ₊₁ (1≤j≤K−1); and

block (f): repeating blocks from b to e, until the plurality of second feature data points Pᵢ (i=1, 2 . . . K) are all calculated.

In block (b), the unit normal vector \vec{N}ⱼ (1≤i≤K−1) at each of the second feature data point Pⱼ (1≤j≤K−1) can be calculated based on the vector form of Snell's Law. When the first nondispersive sphere is a refractive second surface,

$$\vec{{N}_{i}} = \frac{{n}^{′} \vec{{r}_{i}^{′}} - n \vec{{r}_{i}}}{\vert {n}^{′} \vec{{r}_{i}^{′}} - n \vec{{r}_{i}} \vert} ,$$

$$\vec{{r}_{i}} = \frac{\vec{{P}_{i} {S}_{i}}}{\vert \vec{{P}_{i} {S}_{i}} \vert}$$

is a unit vector along a direction of an incident ray of the first nondispersive sphere;

$$\vec{{r}_{j}^{′}} = \frac{\vec{{E}_{j} {P}_{j}}}{\vert \vec{{E}_{j} {P}_{j}} \vert}$$

is a unit vector along a direction of an exit ray of the first nondispersive sphere; and n, n′ is refractive index of a media at two opposite sides of the first nondispersive sphere respectively.

Similarly, when the first nondispersive sphere is a reflective surface,

$$\vec{{N}_{j}} = \frac{\vec{{r}_{j}^{′}} - \vec{{r}_{j}}}{\vert \vec{{r}_{j}^{′}} - \vec{{r}_{j}} \vert} .$$

The unit normal vector \vec{N}ⱼ at the second feature data points Pᵢ (i=1, 2 . . . K) is perpendicular to the first tangent plane at the second feature data points Pᵢ (i=1, 2 . . . K). Thus, the first tangent planes at the second feature data points Pᵢ (i=1, 2 . . . K) can be obtained.

A method for surface fitting the second feature data points Pᵢ (i=1, 2 . . . K) to obtain the first nondispersive sphere is least squares method.

A coordinate of the second feature data point is (xᵢ, yᵢ, zᵢ), and its corresponding normal vector is (uᵢ, vᵢ, −1). When a sphere center is (A, B, C) and a radius is r, an equation of the first nondispersive sphere can be expressed by equation (1):

(xᵢ−A)²+(yᵢ−B)²+(zᵢ−C)²=r² (1).

Calculating a derivation of the equation (1) for x and y, to obtain an expression of a normal vector uᵢ in an x-axis direction and an expression of a normal vector vi in a y-axis direction.

$$\begin{matrix}( 1 + \frac{1}{{u}_{i}^{2}} ) {( {x}_{i} - A )}^{2} + {( {y}_{i} - B )}^{2} = {r}^{2} , & ( 2 ) \\ {( {x}_{i} - A )}^{2} + ( 1 + \frac{1}{{v}_{i}^{2}} ) {( {y}_{i} - B )}^{2} = {r}^{2} . & ( 3 )\end{matrix}$$

Equations (1) (2) and (3) can be rewrite into the matrix form, and equations (4) (5) and (6) of center coordinates can be obtained through a matrix transformation.

$$\begin{matrix}[ \begin{matrix}Σ ( {x}_{i} ( {x}_{i} - \overline{x} ) ) & Σ ( {x}_{i} ( {y}_{i} - \overline{y} ) ) & Σ ( {x}_{i} ( {z}_{i} - \overline{z} ) ) \\ Σ ( {x}_{i} ( {y}_{i} - \overline{y} ) ) & Σ ( {y}_{i} ( {y}_{i} - \overline{y} ) ) & Σ ( {y}_{i} ( {z}_{i} - \overline{z} ) ) \\ Σ ( {x}_{i} ( {z}_{i} - \overline{z} ) ) & Σ ( {y}_{i} ( {z}_{i} - \overline{z} ) ) & Σ ( {z}_{i} ( {z}_{i} - \overline{z} ) )\end{matrix} ] [ \begin{matrix}2 A \\ 2 B \\ 2 C\end{matrix} ] = [ \begin{matrix}Σ ( ( {x}_{i}^{2} + {y}_{i}^{2} + {z}_{i}^{2} ) ( {x}_{i} - \overline{x} ) ) \\ Σ ( ( {x}_{i}^{2} + {y}_{i}^{2} + {z}_{i}^{2} ) ( {y}_{i} - \overline{y} ) ) \\ Σ ( ( {x}_{i}^{2} + {y}_{i}^{2} + {z}_{i}^{2} ) ( {z}_{i} - \overline{z} ) )\end{matrix} ] , & ( 4 ) \\ [ \begin{matrix}\sum {U}_{i} ( {U}_{i} - \overline{U} ) & \sum {U}_{i} ( {y}_{i} - \overline{y} ) & 0 \\ \sum {U}_{i} ( {y}_{i} - \overline{y} ) & \sum {y}_{i} ( {y}_{i} - \overline{y} ) & 0 \\ 0 & 0 & 0\end{matrix} ] [ \begin{matrix}2 A \\ 2 B \\ 2 C\end{matrix} ] = [ \begin{matrix}\sum ( {U}_{i} {x}_{i} + {y}_{i}^{2} ) ( {U}_{i} - \overline{U} ) \\ \sum ( {U}_{i} {x}_{i} + {y}_{i}^{2} ) ( {y}_{i} - \overline{y} ) \\ 0\end{matrix} ] , & ( 5 ) \\ [ \begin{matrix}\sum {x}_{i} ( {x}_{i} - \overline{x} ) & \sum {V}_{i} ( {x}_{i} - \overline{x} ) & 0 \\ \sum {V}_{i} ( {x}_{i} - \overline{x} ) & \sum {V}_{i} ( {V}_{i} - \overline{V} ) & 0 \\ 0 & 0 & 0\end{matrix} ] [ \begin{matrix}2 A \\ 2 B \\ 2 C\end{matrix} ] = [ \begin{matrix}\sum ( {x}_{i}^{2} + {V}_{i} {y}_{i} ) ( {x}_{i} - \overline{x} ) \\ \sum ( {x}_{i}^{2} + {V}_{i} {y}_{i} ) ( {V}_{i} - \overline{V} ) \\ 0\end{matrix} ] . & ( 6 )\end{matrix}$$

The normal vector (uᵢ, vᵢ, −1) decides a direction of light rays, thus, both a coordinate error and a normal error during the surface fitting should be considered to obtain an accurate sphere. The coordinate error and the normal error are linearly weighted to calculate the sphere center (A, B, C) and the radius r.

Equation (4)+ω×equation (5)+ω×equation (6) (7),

Equation (1)+ω×equation (2)+ω×equation (3) (8),

In equations (7) and (8), ω is a weight of the normal error. The sphere center (A, B, C) can be obtained by equation (7), and the radius r can be obtained by equation (8).

After the first nondispersive sphere is obtained, the radius of the first nondispersive sphere can be further changed to obtain a third nondispersive sphere, an optical power of the first nondispersive sphere is changed. In one embodiment, rₐ′=εₐ×rₐ, εₐ=0.5˜1.5, wherein, rₐ is the radius of the first nondispersive sphere, and rₐ′ is the radius of the third nondispersive sphere. The radius of each of the nondispersive spheres of the nondispersive spherical optical system can be further changed to change the optical power each of the nondispersive spheres.

In block (B14), a method of calculating a plurality of third feature data points on the second nondispersive sphere is the same as the method of calculating the plurality of second feature data points on the first nondispersive sphere. A method of surface fitting the plurality of third feature data points on the second nondispersive sphere is the same as the method of surface fitting the second feature data points on the first nondispersive sphere.

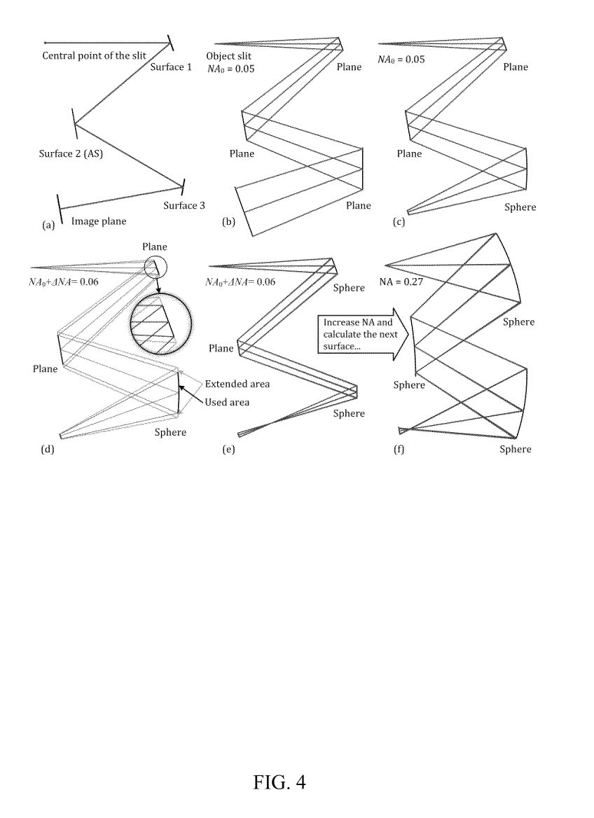

Referring to FIG. 4, in one embodiment, the initial system comprises three initial surfaces; the three initial surfaces are a primary mirror initial plane, a secondary mirror initial plane and a tertiary mirror initial plane. First, the numerical aperture is NA₁, the spherical radius of a tertiary mirror is obtained according to the calculation method in step B13; keeping the primary mirror initial plane and the spherical radius of the tertiary mirror unchanged, increasing the numerical aperture by ΔNA to NA₂, and calculating a spherical radius of the primary mirror according to the calculation method in step B13; keeping the spherical radius of the primary mirror and the spherical radius of the tertiary mirror unchanged, increasing the numerical aperture by ΔNA to NA3, and calculating a spherical radius of the secondary mirror according to the calculation method in step B13; repeating above steps, in each step, calculating the spherical radius of one of the three mirrors in a order of tertiary mirrors-primary mirror-secondary mirror, at the same time, the numerical aperture of the nondispersive spherical optical system increases to ΔNA as NA4, NA5, . . . until NA is reached.

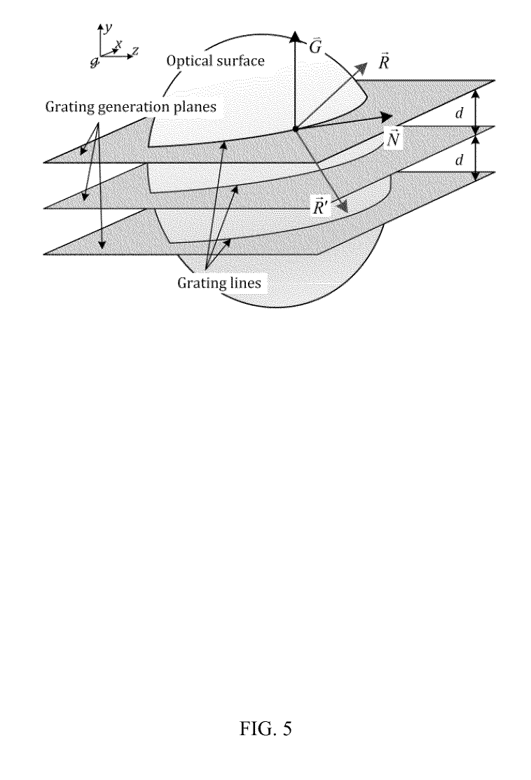

In block (B2), referring to FIG. 5, in one embodiment, the dispersion element is a grating; and the grating is located on a surface of the secondary mirror, and the grating is defined by the intersecting surfaces of an optical surface and a series of parallel planes. The dispersive spherical optical system that initially meets the dispersion requirements can be obtained by calculating a grating pitch of the grating, and the grating pitch is a distance between adjacent grating surfaces. A point on the grating surface is defined as a start point, a normal vector of the grating surface is defined as “\vec{G}”, a normal vector of the optical surface is defined as “\vec{N}”, and the grating pitch is defined as “d”. In one embodiment, only “\vec{G}” and “d” are considered.

The grating pitch “d” is determined by a spectroscopic specification and a shape of the nondispersive spherical optical system. A focal length between the secondary mirror and the image plane is defined as f′, an incident angle of a chief ray at the central field on the secondary mirror is defined as θᵢ; and f′ and θᵢ can be obtained by real ray tracing. A spectral image height h_{spec} can be obtained by h_{spec}=f× tan θ_{w} and h_{spec}=2p×(λ₁−λ₂)/r_{w}; θ_{w} is a spectral bandwidth angle, r_{w} is a spectral resolution, p is a pixel pitch, λ₁ is a maximum wavelength within the spectrum, and λ₂ is a minimum wavelength within the spectrum. From h_{spec}=f× tan θ_{w} and h_{spec}=2p×(λ₁−λ₂)/r_{w}, formula (9) can be obtained,

tan θ_{w}=2p·(λ₁−λ₂)/(r_{w}·f′). (9).

For the chief ray at the central field, mλ₁=d(sin θ₁− sin θ₁) and mλ₂=d(sin θ₁− sin θ₂). θ₁ is a diffraction angle at λ₁, and θ₂ is a diffraction angle at λ₂, m is a diffraction order. In the formula (9), θ_{w}=|θ₁−θ₂|, the grating pitch “d” can be obtained by substituting the values of θ₁ and θ₂.

In one embodiment, an imaging spectrometer spherical system that initially satisfies the dispersion requirement can be obtained by calculating the grating pitch.

In block (B3), during constructing the dispersive spherical optical system in block (B2) into the dispersive freeform surface optical system comprising the freeform surface. The first feature data points on the freeform surface needs to be calculated, and then the first feature data points are surface fitted to obtain the freeform surface. A method of calculating the first feature data points on the freeform surface of the dispersive freeform surface system is the same as the method of calculating the second feature data points on the first nondispersive sphere in block (B2).

After the plurality of feature rays is dispersed by the dispersion element, the plurality of feature rays of each wavelength finally intersects the image surface at the ideal image points; therefore, a propagation path of the plurality of feature rays not only needs to satisfy the Fermat principle, but also satisfies the diffraction law of the dispersion element.

A freeform surface on which the dispersion element is placed of the freeform surface optical system is defined as a first freeform surface, a freeform surface located adjacent to and before the first freeform surface is defined as a second freeform surface, and a freeform surface located adjacent to and behind the first freeform surface is defined as a third freeform surface. When calculating the coordinates and normal vectors of the feature data points on the second freeform surface, a propagation direction of the plurality of feature rays of the feature data points on the second freeform surface needs to be solved, and then the normal vectors of the feature data points on the second freeform surface are solved.

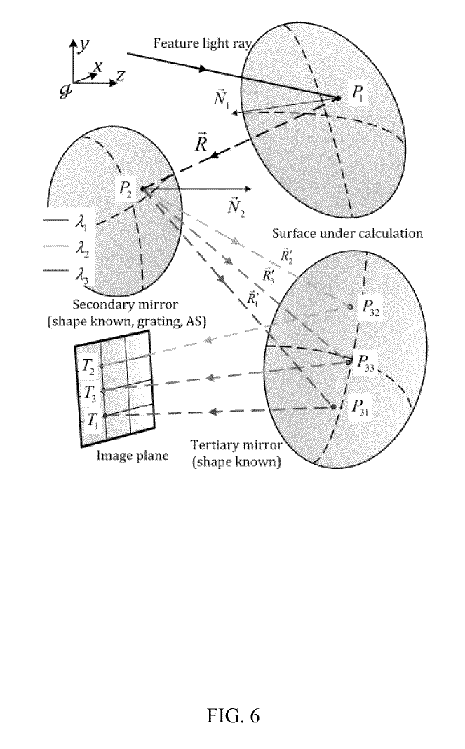

Referring to FIG. 6, the coordinates of the feature data point P₁ on the second freeform surface is defined as (x₁, y₁, z₁); the propagation direction of the feature ray leaving the feature data point P₁ is solved to calculate the normal vector of the feature data point P₁. An intersection of the feature ray corresponding to P₁ and the first freeform surface is defined as P₂ (x₁, y₁, z₁). A dispersion occurs after the feature ray passes through the grating, and N light rays having different wavelengths are considered, and the N light rays are defined as λ₁, λ₂, . . . , λw, . . . , λ_{N}. The intersections of the N light rays having different wavelengths and the third freeform surface are defined as P_{3w} (x_{3w}, y_{3w}, z_{3w}), and the ideal image points of the N light rays having different wavelengths on the image surface are defined as T_{w} (x_{tw}, y_{tw}, z_{tw}); and w=1, 2, . . . , N.

A refractive index of a medium is assumed as 1.0. Then, a sum of the optical path lengths of the light rays with different wavelengths from P₁ to T_{w} is given as formula (10):

$$L = {L}_{1} + {\sum }_{w = 1}^{N} {L}_{2 w} + {\sum }_{w = 1}^{N} {L}_{3 w} . \qquad ( 10 )$$

In the formula (10), L₁, L_{2w} and L_{3w} represent the optical path lengths of paths P₁P₂, P₂P_{3w}, and P_{3w}T_{w}, respectively, and w=1, 2, . . . , N.

L₁=\sqrt{(x₁−x₂)²+(y₁−y₂)²+(z₁−z₂)²}

L_{2w}=\sqrt{(x₂−x_{3w})²+(y₂−y_{3w})²+(Z₂−z_{3w})²}

L_{3w}=\sqrt{(x_{3w}−x_{tw})²+(y_{3w}−y_{tw})²+(z_{3w}−z_{tw})²} (11).

Based on the generalized grating ray-tracing equations and the Fermat principle, the ray tracing equation for multi-wavelength feature light rays satisfying the dispersion law of diffraction grating is given as formula (12):

$${\sum }_{w = 1}^{N} \{ \begin{matrix}{( \partial L \text{/} \partial {x}_{3 w} )}^{2} + {( \partial L \text{/} \partial {y}_{3 w} )}^{2} + \\ {[ ( \partial L \text{/} \partial {x}_{2} ) \text{/} ( m {λ}_{w} \text{/} d ) + {g}_{x} + {g}_{y} + ( \partial {z}_{2} \text{/} \partial {x}_{2} ) \cdot {g}_{z} ]}^{2} + \\ {[ ( \partial L \text{/} \partial {y}_{2} ) \text{/} ( m {λ}_{w} \text{/} d ) + {g}_{x} + {g}_{y} + ( \partial {z}_{2} \text{/} \partial {y}_{2} ) \cdot {g}_{z} ]}^{2}\end{matrix} \} = 0 , \qquad ( 12 )$$

gₓ and g_{y} are the x and y components of \vec{G}, respectively, m is the diffraction order, and L is given by formula (10) and formula (11). An intersection (x₂, y₂, z₂) of the feature ray and the first freeform surface can be obtained by formula (12), and thus a direction vector of an outgoing ray at point P₁ and the normal vector \vec{N}₁ of the point P₁ can also be obtained. In one embodiment, the first freeform surface is the secondary mirror, the second freeform surface is the primary mirror, and the third freeform surface is the tertiary mirror.

The above method is also applicable to dispersion elements other than gratings, as long as a generalized numerical equation for real ray tracing similar to formula (12) through the dispersion element is given; for example, prisms, diffractive optics.

For the method of calculating the feature data points on the first freeform surface, there are multiple unit normal vectors \vec{N}ᵢ at the feature data point Pᵢ. The normal vectors of the grating surface can change the directions in which the light rays emerge. Therefore, an optimal normal vector needs to be solved; and the optimal normal vector can deflect feature rays with different wavelengths towards their corresponding ideal image points.

The optimal normal vector can be obtained by an optimization algorithms, and the optimization algorithms comprises:

the coordinates of the first feature data point P₂ on the first freeform surface have been obtained, calculating the normal vector \vec{N}₂ of the first feature data point P₂;

considering the N light rays λw, w=1, 2, . . . , N, and the N light rays are expected to arrive at T_{w} on the image plane, the emerging light rays' directional vectors R_{w}′, where w=1, 2, . . . , N, can be obtained independently by the Fermat principle; according to the diffraction formula [U. W. Ludwig], \vec{N}₂ satisfies the formula (13),

(\vec{R}_{w}′−\vec{R})×\vec{N}₂−(mλ_{w}/d)\vec{G}×\vec{N}₂=0 (13),

\vec{N}₂ can be given in a form of direction cosines as:

\vec{N}₂=(cos α, cos β,\sqrt{1−cos²α−cos²β}),

α and β represent the direction angles in the global Cartesian coordinates g; and

substituting \vec{N}₂=(cos α, cos β,\sqrt{1− cos²α− cos²β}) into the formula (13) and taking the sum of the squares as a cost function F for the optimization algorithms,

$$Γ ( α , β ) = {\sum }_{w = 1}^{N} {[ ( {\vec{R}}_{w}^{′} - \vec{R} ) \times {\vec{N}}_{2} - ( m {λ}_{w} \text{/} d ) \vec{G} \times {\vec{N}}_{2} ]}^{2} ,$$

minimizing Γ with respect to both α and β, to obtain the optimal normal vector \vec{N}₂. under ideal conditions, the minimized value of Γ is zero.

The feature data points on each freeform surface of the dispersive freeform surface optical system are surface fitted to obtain a freeform surface, thereby obtaining the dispersive freeform surface optical system.

In block (B5), an iterative algorithm is used to obtain the freeform surface optical system with dispersion element elements, and an effect of the iterative algorithm can be evaluated by a root mean square (RMS) deviation between the actual intersection of the plurality of feature rays with the target surface and the ideal target points. A RMS value σ_{RMS} can be expressed:

$${σ}_{RMS} = \sqrt{\frac{{\sum }_{w = 1}^{N} {\sum }_{k = 1}^{M} {σ}_{wk}^{2}}{M}} ,$$

wherein N is the total number of wavelengths considered, M is the number of the feature rays, σ_{wk} is a distance between the actual intersection of the K^{th} feature ray of the w^{th} wavelength with the target surface and the ideal target points.

The iterative algorithm can continue until σ_{RMS} reaches the requirements or converges to a certain value. After the iterative algorithm, the freeform surface optical system with dispersion element elements usually meets the design requirements and has a good image quality.

Furthermore, a step of optimizing the freeform surface optical system with dispersion element elements obtained in block (B5) can be performed, and the freeform surface optical system with dispersion element elements is used as an initial system of optimization.

In one embodiment, after the freeform surface optical system with dispersion element elements is obtained, further comprising a step of manufacturing the freeform surface optical system with dispersion element elements obtained in block (B5).

The freeform surface of the freeform surface optical system with dispersion element elements can be solved in any order. The method of designing the freeform surface optical system with dispersion element elements is implemented by a computer processor.

The method of designing the freeform surface optical system with dispersion elements can quickly and efficiently design imaging spectrometers or the freeform surface optical system with other dispersion elements, such as a diffraction grating, a prism, a DOE or the like. The method as disclosed can successfully broaden an applicability of the direct design method from nondispersive systems to dispersive systems. With the benefits of faster computation speeds and the development of artificial intelligence, the direct design method disclosed herein can serve users well by offering massive quantities of initial designs that can not only be used for theoretical studies in optics, but also for high-performance optical system design. In addition, the method of designing the freeform surface optical system with dispersion elements can solve the “field-aperture-wavelength” (FPW) problem that is particularly applicable to and efficient for design with freeform surfaces, the freeform surface optical system with dispersive device designed by this method enables all fields, all apertures and all wavelengths of light to satisfy their respective image relationships.

Depending on the embodiment, certain blocks/steps of the methods described may be removed, others may be added, and the sequence of blocks may be altered. It is also to be understood that the description and the claims drawn to a method may comprise some indication in reference to certain blocks/steps. However, the indication used is only to be viewed for identification purposes and not as a suggestion as to an order for the blocks/steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method of designing a freeform surface optical system with dispersion elements, comprising:
step (B1), constructing a nondispersive spherical optical system by using a slit of the freeform surface optical system with dispersion elements as an object, and the nondispersive spherical optical system comprising a nondispersive sphere;
step (B2), placing a dispersion element on the nondispersive sphere, to construct a dispersive spherical optical system comprising a dispersive sphere; and the dispersive sphere having the same shape as the nondispersive sphere;
step (B3), constructing the dispersive spherical optical system in step (B2) into a dispersive freeform surface optical system comprising a freeform surface;
step (B4), defining a plurality of intersections between a plurality of feature rays and the freeform surface as a plurality of first feature data points on the freeform surface; keeping a plurality of coordinates of the plurality of first feature data points unchanged, recalculating a plurality of normal vectors of the plurality of first feature data points according to an object relationship to obtain a plurality of new normal vectors; and surface fitting the plurality of coordinates and the plurality of new normal vectors, to obtain a new freeform surface; and
step (B5), repeating step (B4) until all freeform surfaces of the dispersive freeform surface optical system being recalculated to new freeform surfaces, and the freeform surface optical system with dispersion element elements being obtained.

2. The method of claim 1, wherein the method of constructing the nondispersive spherical optical system comprises:
step (B11), establishing an initial system and selecting the plurality of feature rays, the initial system comprises a plurality of initial surfaces, and each of the plurality of initial surfaces corresponds to one freeform surface of the freeform surface optical system with dispersion elements; and a numerical aperture of the initial system is NA₁;
step (B12), assuming a numerical aperture of the nondispersive spherical optical system is NA, NA₁<NA; and selecting n values at equal intervals between NA₁ and NA, then values are defined as NA₂, NA₃, . . . , and NAₙ, and an equal interval value of the n values is ΔNA;
step (B13), a nondispersive sphere of the nondispersive spherical optical system is defined as a first nondispersive sphere, and calculating a first spherical radius of the first nondispersive sphere;
step (B14), another nondispersive sphere of the nondispersive spherical optical system is defined as a second nondispersive sphere, keeping other initial surfaces except the initial surfaces corresponds to the first nondispersive sphere and the second nondispersive sphere unchanged; increasing a numerical aperture by ΔNA to NA₂, increasing a quantity of the plurality of feature rays, and calculating a second spherical radius of the second nondispersive sphere; repeating step (B14) until the spherical radius of all nondispersive spheres of the nondispersive spherical optical system are obtained; and
step (B15), repeating step (B13) and step (B14), and loop calculating the spherical radius of each nondispersive sphere of the nondispersive spherical optical system, until the numerical aperture is increased to NA.

3. The method of claim 2, wherein in step (B12), NA₁<0.01 multiply by NA.

4. The method of claim 2, wherein a value of n is larger than a number of nondispersive spheres of the nondispersive spherical optical system.

5. The method of claim 2, wherein the method of calculating the first spherical radius of the first nondispersive sphere comprises: calculating a plurality of intersections of the plurality of feature rays with the first nondispersive sphere based on a object-image relationship and Snell's law, the plurality of intersections are the plurality of second feature data points on the first nondispersive sphere; and surface fitting the plurality of second feature data points to obtain an equation of the first nondispersive sphere and the first spherical radius of the first nondispersive sphere.

6. The method of claim 5, wherein the plurality of second feature data points on the first nondispersive sphere is defined as Pᵢ, i=1, 2 . . . K, and K refers a quantity of the plurality of feature rays; and the method of calculating the plurality of second feature data points on the first nondispersive sphere comprises:
step (a): defining a first intersection point of a first feature ray R₁ and the initial surface corresponding to the first nondispersive sphere as the second feature data point P₁;
step (b): a second feature data point Pⱼ has been obtained, 1≤j≤K−1, a unit normal vector \vec{N}ⱼ at the second feature data point Pⱼ is calculated based on the vector form of Snell's law;
step (c): making a first tangent plane through the second feature data point Pⱼ, and K−j second intersections are obtained by the first tangent plane intersecting with remaining K−j feature rays; a second intersection Qⱼ₊₁, which is nearest to the second feature data point Pⱼ, is fixed; and a feature ray corresponding to the second intersection Qⱼ₊₁ is defined as Rⱼ₊₁, a shortest distance between the second intersection Qⱼ₊₁ and the second feature data point Pⱼ is defined as dⱼ;
step (d): making a second tangent plane at j−1 second feature data points that are obtained before the second feature data point P respectively; thus, j−1 second tangent planes can be obtained, and j−1 third intersections can be obtained by the j−1 second tangent planes intersecting with a feature ray Rⱼ₊₁; in each of the j−1 second tangent planes, each of the third intersections and its corresponding second feature data point form an intersection pair; the intersection pair, which has the shortest distance between a third intersection and its corresponding second feature data point, is fixed; and the third intersection and the shortest distance is defined as Q′ⱼ₊₁ and d′ⱼ respectively;
step (e): comparing dⱼ and d′ⱼ, if dⱼ≤d′ⱼ, Qⱼ₊₁ is taken as the next second feature data point Pⱼ₊₁; otherwise, Q′ⱼ₊₁ is taken as the next second feature data point Pⱼ₊₁; and
step (f): repeating blocks from b to e, until the plurality of second feature data points Pᵢ are all calculated. obtain an equation of the first nondispersive sphere

7. The method of claim 5, wherein the method of surface fitting the second feature data points comprises:
defining a coordinate of the second feature data points as (xᵢ, yᵢ, zᵢ), a normal vector corresponding to (xᵢ, yᵢ, zᵢ) as (uᵢ, vᵢ, −1), a sphere center as (A, B, C) and a radius as r, an equation of the first nondispersive sphere is expressed by a first equation:
(xᵢ−A)²+(yᵢ−B)²+(zᵢ−C)²=r²;
calculating a derivation of the first equation for x and y, to obtain a second expression of a normal vector uᵢ in an x-axis direction and a third expression of a normal vector vᵢ in a y-axis direction, wherein
the second expression is
$$( 1 + \frac{1}{{u}_{i}^{2}} ) {( {x}_{i} - A )}^{2} + {( {y}_{i} - B )}^{2} = {r}^{2} ,$$
and
the third expression is
$${( {x}_{i} - A )}^{2} + ( 1 + \frac{1}{{v}_{i}^{2}} ) {( {y}_{i} - B )}^{2} = {r}^{2} ;$$
rewriting the first expression, the second expression and the third expression into a matrix form, to obtain a fourth expression, a fifth expression, and a sixth expression, wherein the fourth expression is:
$$[ \begin{matrix}Σ ( {x}_{i} ( {x}_{i} - \overline{x} ) ) & Σ ( {x}_{i} ( {y}_{i} - \overline{y} ) ) & Σ ( {x}_{i} ( {z}_{i} - \overline{z} ) ) \\ Σ ( {x}_{i} ( {y}_{i} - \overline{y} ) ) & Σ ( {y}_{i} ( {y}_{i} - \overline{y} ) ) & Σ ( {y}_{i} ( {z}_{i} - \overline{z} ) ) \\ Σ ( {x}_{i} ( {z}_{i} - \overline{z} ) ) & Σ ( {y}_{i} ( {z}_{i} - \overline{z} ) ) & Σ ( {z}_{i} ( {z}_{i} - \overline{z} ) )\end{matrix} ] [ \begin{matrix}2 A \\ 2 B \\ 2 C\end{matrix} ] = [ \begin{matrix}Σ ( ( {x}_{i}^{2} + {y}_{i}^{2} + {z}_{i}^{2} ) ( {x}_{i} - \overline{x} ) ) \\ Σ ( ( {x}_{i}^{2} + {y}_{i}^{2} + {z}_{i}^{2} ) ( {y}_{i} - \overline{y} ) ) \\ Σ ( ( {x}_{i}^{2} + {y}_{i}^{2} + {z}_{i}^{2} ) ( {z}_{i} - \overline{z} ) )\end{matrix} ] ,$$
the fifth expression is:
$$[ \begin{matrix}\sum {U}_{i} ( {U}_{i} - \overline{U} ) & \sum {U}_{i} ( {y}_{i} - \overline{y} ) & 0 \\ \sum {U}_{i} ( {y}_{i} - \overline{y} ) & \sum {y}_{i} ( {y}_{i} - \overline{y} ) & 0 \\ 0 & 0 & 0\end{matrix} ] [ \begin{matrix}2 A \\ 2 B \\ 2 C\end{matrix} ] = [ \begin{matrix}\sum ( {U}_{i} {x}_{i} + {y}_{i}^{2} ) ( {U}_{i} - \overline{U} ) \\ \sum ( {U}_{i} {x}_{i} + {y}_{i}^{2} ) ( {y}_{i} - \overline{y} ) \\ 0\end{matrix} ] ,$$
and
the sixth expression is
$$[ \begin{matrix}\sum {x}_{i} ( {x}_{i} - \overline{x} ) & \sum {V}_{i} ( {x}_{i} - \overline{x} ) & 0 \\ \sum {V}_{i} ( {x}_{i} - \overline{x} ) & \sum {V}_{i} ( {V}_{i} - \overline{V} ) & 0 \\ 0 & 0 & 0\end{matrix} ] [ \begin{matrix}2 A \\ 2 B \\ 2 C\end{matrix} ] = [ \begin{matrix}\sum ( {x}_{i}^{2} + {V}_{i} {y}_{i} ) ( {x}_{i} - \overline{x} ) \\ \sum ( {x}_{i}^{2} + {V}_{i} {y}_{i} ) ( {V}_{i} - \overline{V} ) \\ 0\end{matrix} ] ;$$
and
obtaining the sphere center (A, B, C) by the fourth expression+ω× the fifth expression+ω× the sixth expression, and obtaining the radius r by the first expression+ω× the second expression+ω× the third expression, wherein ω is a weight of the normal error.

8. The method of claim 5, wherein after the nondispersive spherical optical system is obtained, a radius of each of the nondispersive spheres of the nondispersive spherical optical system is changed to obtain new nondispersive spheres.

9. The method of claim 8, wherein rₐ′=εₐ×rₐ, εₐ=0.5˜1.5, rₐ is the radius of each of the nondispersive spheres of the nondispersive spherical optical system, and rₐ′ is a radius of each of the new nondispersive spheres.

10. The method of claim 1, wherein the dispersion element is a grating, and the grating is defined by the intersecting surfaces of an optical surface and a series of parallel planes.

11. The method of claim 10, wherein the dispersive spherical optical system is obtained by calculating a grating pitch of the grating, and the grating pitch is a distance between adjacent grating surfaces.

12. The method of claim 1, wherein a freeform surface of the freeform surface optical system configured to place the dispersion element is defined as a first freeform surface, a freeform surface located adjacent to and before the first freeform surface is defined as a second freeform surface, and a freeform surface located adjacent to and behind the first freeform surface is defined as a third freeform surface; a method of solving the normal vectors of the feature data points on the second freeform surface comprises:
defining the coordinates of a feature data point P₁ on the second freeform surface as (x₁, y₁, z₁), and an intersection of the feature ray corresponding to the feature data point P₁ and the first freeform surface as P₂ (x₁, y₁, z₁);
a dispersion occurs after the feature ray passes through the dispersion element, and considering N light rays having different wavelengths λ₁, λ₂, . . . , λw, . . . , λ_{N}; defining the intersections of the N light rays having different wavelengths and the third freeform surface as P_{3w} (x_{3w}, y_{3w}, z_{3w}), and defining the ideal image points of the N light rays having different wavelengths on the image surface as T_{w} (x_{tw}, y_{tw}, z_{tw}), and w=1, 2, . . . , N;
assuming a refractive index of a medium as 1.0, a sum of the optical path lengths of the light rays with different wavelengths from P₁ to T_{w} is:
$$L = {L}_{1} + {\sum }_{w = 1}^{N} {L}_{2 w} + {\sum }_{w = 1}^{N} {L}_{3 w} , \qquad ( a )$$
wherein, L₁, L_{2w} and L_{3w} represent the optical path lengths of paths P₁, P₂, P₂P_{3w}, and P_{3w}T_{w}, respectively, and w=1, 2, . . . , N,
L₁=\sqrt{(x₁−x₂)²+(y₁−y₂)²+(z₁−z₂)²}
L_{2w}=\sqrt{(x₂−x_{3w})²+(y₂−y_{3w})²+(z₂−z_{3w})²}
L_{3w}=\sqrt{(x_{3w}−x_{tw})²+(y_{3w}−y_{tw})²+(z_{3w}−z_{tw})²} (b),
based on the generalized ray-tracing equations and the Fermat principle, the ray tracing equation for multi-wavelength feature light rays satisfying the dispersion law of diffraction grating is:
$${\sum }_{w = 1}^{N} \{ \begin{matrix}{( \partial L \text{/} \partial {x}_{3 w} )}^{2} + {( \partial L \text{/} \partial {y}_{3 w} )}^{2} + \\ {[ ( \partial L \text{/} \partial {x}_{2} ) \text{/} ( m {λ}_{w} \text{/} d ) + {g}_{x} + {g}_{y} + ( \partial {z}_{2} \text{/} \partial {x}_{2} ) \cdot {g}_{z} ]}^{2} + \\ {[ ( \partial L \text{/} \partial {y}_{2} ) \text{/} ( m {λ}_{w} \text{/} d ) + {g}_{x} + {g}_{y} + ( \partial {z}_{2} \text{/} \partial {y}_{2} ) \cdot {g}_{z} ]}^{2}\end{matrix} \} = 0 , \qquad ( c )$$
gₓ is a x component of \vec{G}, g_{y} is a y component of \vec{G}, m is a diffraction order, an intersection (x₂, y₂, z₂) of the feature ray and the first freeform surface is obtained by formula (c), and thus a normal vector \vec{N}₁ of the feature data point P₁ is obtained.

13. The method of claim 1, wherein a freeform surface of the freeform surface optical system used to place the dispersion element is defined as a first freeform surface, there are multiple unit normal vectors at the first feature data points on the first freeform surface, and an optimal normal vector is solved.

14. The method of claim 13, wherein the optimal normal vector is obtained by an optimization algorithms, and the optimization algorithms comprises:
calculating a normal vector \vec{N}₂ of the first feature data point P₂ after the coordinates of the first feature data point P₂ on the first freeform surface have been obtained;
considering N light rays λ_{w}, w=1, 2, . . . , N, and the N light rays are expected to arrive at T_{w} on the image plane, the emerging light rays' directional vectors R_{w}′ is obtained independently by the Fermat principle according to a diffraction formula, wherein w=1, 2, . . . , N; \vec{N}₂ satisfies formula (d),
(\vec{R}_{w}′−\vec{R})×\vec{N}₂−(mλ_{w}/d)\vec{G}×\vec{N}₂=0 (d),
\vec{N}₂ is given in a form of direction cosines as:
N₂=(cos α, cos β,\sqrt{1−cos²α−cos²β}),
α and β represent the direction angles in the global Cartesian coordinates g; and
substituting \vec{N}₂=(cos α, cos β,\sqrt{1− cos²α− cos²β}) into the formula (d) and taking a sum of the squares as a cost function F for the optimization algorithms,
$$Γ ( α , β ) = {\sum }_{w = 1}^{N} {[ ( {\vec{R}}_{w}^{′} - \vec{R} ) \times {\vec{N}}_{2} - ( m {λ}_{w} \text{/} d ) \vec{G} \times {\vec{N}}_{2} ]}^{2} ,$$
minimizing Γ with respect to both α and β, to obtain the optimal normal vector \vec{N}₂ under ideal conditions, and the minimized value of Γ is zero.

15. The method of claim 1, wherein the step of optimizing the freeform surface optical system with dispersion element elements obtained in step (B5) is performed, and the freeform surface optical system with dispersion element elements is used as an initial system of optimization.

16. The method of claim 1, further comprising a step of manufacturing the freeform surface optical system with dispersion element elements obtained in step (B5).

17. The method of claim 1, wherein the dispersion element is a diffraction grating, a prism, or a diffractive optics.
